(19) United States
(12) Patent Application Publication
(10) Pub. No.: US 2026/0109302 A1
(43) Pub. Date: Apr. 23, 2026

(54) VEHICLE COMMUNICATION SYSTEM

(71) Applicant: Robert Smith, Chicago, IL (US)

(72) Inventor: Robert Smith, Chicago, IL (US)

(21) Appl. No.: 18/919,043

(22) Filed: Oct. 17, 2024

(51) Int. Cl. B60R 11/02; B60R 1/12; B60R 1/25; B60R 11/00; B60R 16/033

(52) U.S. Cl. CPC B60R 11/0217; B60R 1/12; B60R 1/25; B60R 11/0247; B60R 16/033; B60R 2001/1253; B60R 2011/0005; B60R 2011/004

(57) ABSTRACT

A vehicle communication system includes an exterior communication assembly, a control assembly, and wiring. The exterior communication assembly is designed to be mounted at a driver side mirror of a vehicle. The exterior communication assembly includes a speaker and a microphone. The control assembly includes a battery in a battery housing designed to be mounted under a vehicle dashboard, a microprocessor operatively connected to the battery, and a wireless transceiver operatively connected to the microprocessor. The wireless transceiver is designed to operatively connect the first communication assembly to a personal electronic device having a speaker and a microphone. The wiring connects the exterior communication assembly to the control assembly and is designed to be installed in and through a wiring conduit in a driver side mirror and a driver side door.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to communication systems and accessories for vehicles and more particularly pertains to a new vehicle communication system to allow persons to communicate and monitor other persons outside a car, specifically adjacent a driver side mirror or door. The vehicle communication system has an exterior communication assembly mounted at the driver side mirror of a vehicle, such as a car or truck, which includes a speaker and a microphone. The exterior communication assembly is wired to a control assembly inside the vehicle, which is wirelessly connected to a personal electronic device, such as a mobile phone. The user can communicate with persons outside the vehicle without needing to open the door or roll down the window, thereby keeping the person safe from potential danger and allowing communication in inclement weather. The vehicle communication system could be used to talk to any person outside the vehicle, such as for example, strangers, law enforcement personnel, and drive-though operators, without the need to open the door or roll down the window. In one embodiment the vehicle communication system includes a camera for video transmission and a motion detector to detect persons approaching the vehicle.

### (2) Description of Related Art Including Information Disclosed Under 37 CFR 1.97 and 1.98

The prior art relates to communication systems and accessories for vehicles. The prior art, as best understood, does not disclose a vehicle communication system that includes an exterior communication assembly, a control assembly, and wiring, wherein the exterior communication assembly is designed to be mounted at a driver side mirror of a vehicle, and wherein the wireless transceiver is designed to operatively connect the first communication assembly to a personal electronic device having a speaker and a microphone. In addition, the exterior communication assembly can have a camera for video transmission.

### BRIEF SUMMARY OF THE INVENTION

An embodiment of the disclosure meets the needs presented above in a vehicle communication system generally comprising an exterior communication assembly, a control assembly, and wiring. The exterior communication assembly is designed to be mounted at a driver side mirror of a vehicle. The exterior communication assembly includes a speaker and a microphone. The control assembly includes a battery in a battery housing designed to be mounted under a vehicle dashboard, a microprocessor operatively connected to the battery, and a wireless transceiver operatively connected to the microprocessor. The wireless transceiver is designed to operatively connect the first communication assembly to a personal electronic device having a speaker and a microphone. The wiring connects the exterior communication assembly to the control assembly and is designed to be installed in and through a wiring conduit in a driver side mirror and a driver side door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicle communication system according to a first embodiment of the disclosure in use.

FIG. 2 is a close view up of the first embodiment of the disclosure.

FIG. 3 is a top view of the first embodiment of the disclosure in use.

FIG. 4 is a block diagram of the first embodiment of the disclosure.

FIG. 5 is a perspective view of a second embodiment of the disclosure.

FIG. 6 is a block diagram of the second embodiment of the disclosure.

### DETAILED DESCRIPTION OF THE INVENTION

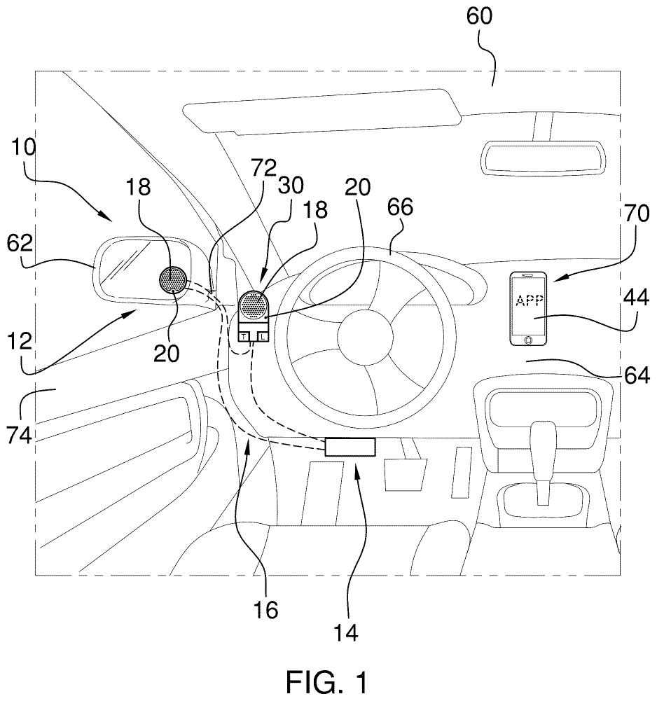

With reference now to the drawings, and in particular to FIGS. 1 through 6 thereof, a new vehicle communication system embodying the principles and concepts of an embodiment of the disclosure and generally designated by the reference numeral 10 will be described.

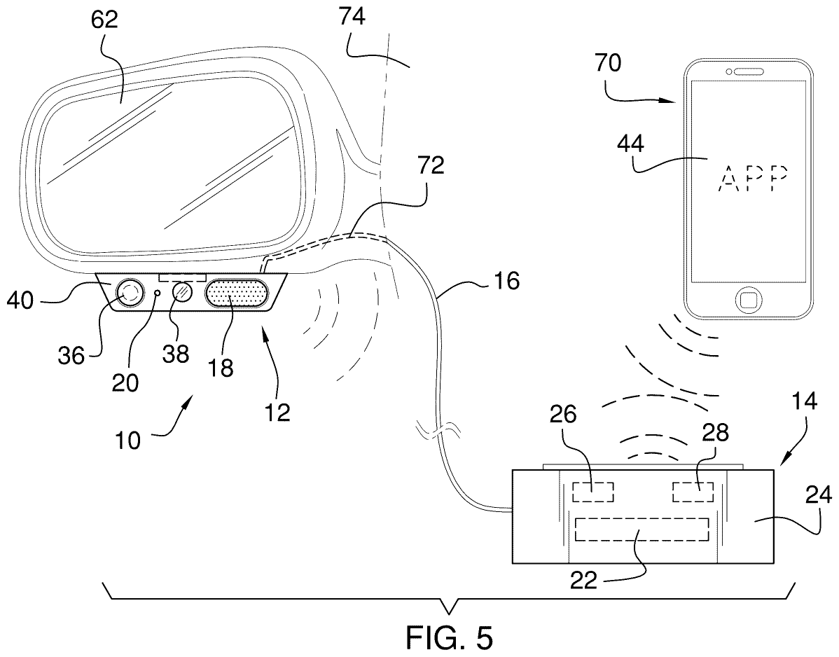

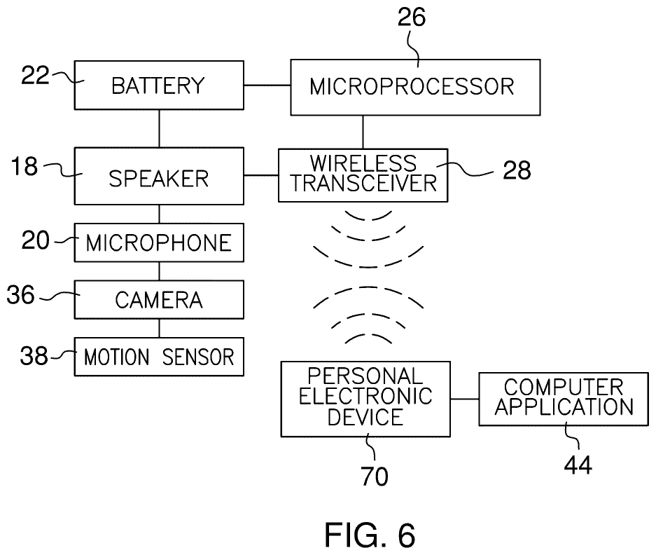

FIGS. 1 through 4 show a first embodiment of the vehicle communication system 10, and FIGS. 5 and 6 show a second embodiment of the vehicle communication system 10. Components of one embodiment could be used or adapted for use in the other embodiment. In each of the first and second embodiments, the vehicle communication system 10 includes an exterior communication assembly 12, a control assembly 14, and wiring 16. The exterior communication assembly 12 is designed to be mounted at a driver side mirror 62 of a vehicle 60. The exterior communication assembly 12 includes a speaker 18 and a microphone 20. The control assembly 14 includes a battery 22 in a battery housing 40 24 designed to be mounted under a vehicle dashboard 64, a microprocessor 26 operatively connected to the battery 22, and a wireless transceiver 28 operatively connected to the microprocessor 26. The wireless transceiver 28 is designed to operatively connect the exterior communication assembly 12 to a personal electronic device 70 having a speaker 18 and a microphone 20. The wiring 16 connects the exterior communication assembly 12 to the control assembly 14 and is designed to be installed in and through a wiring conduit 72 in a driver side mirror 62 and a driver side door 74.

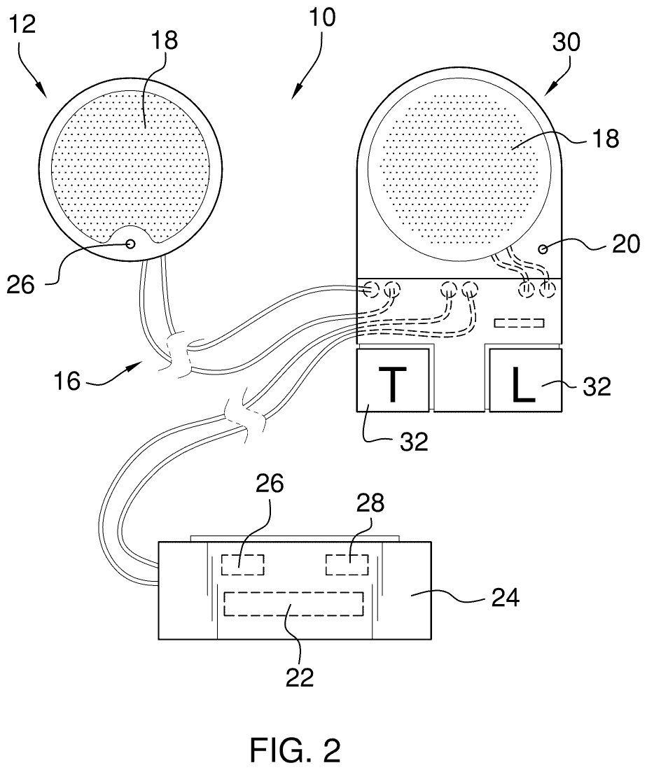

As shown in FIG. 2, the wireless transceiver 28 and the microprocessor 26 are positioned in the battery housing 40 24. However, in one possible embodiment, the wireless transceiver 28 and microprocessor 26 could be located elsewhere, such as in the driver side mirror 62.

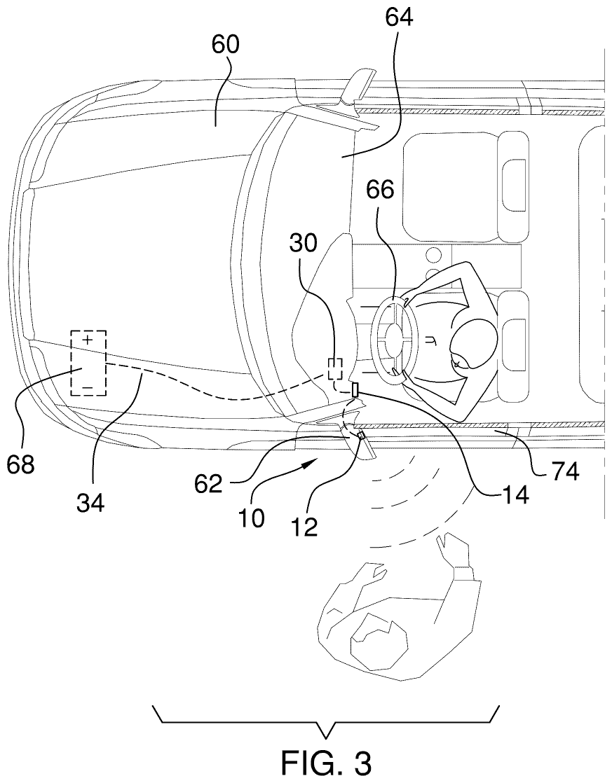

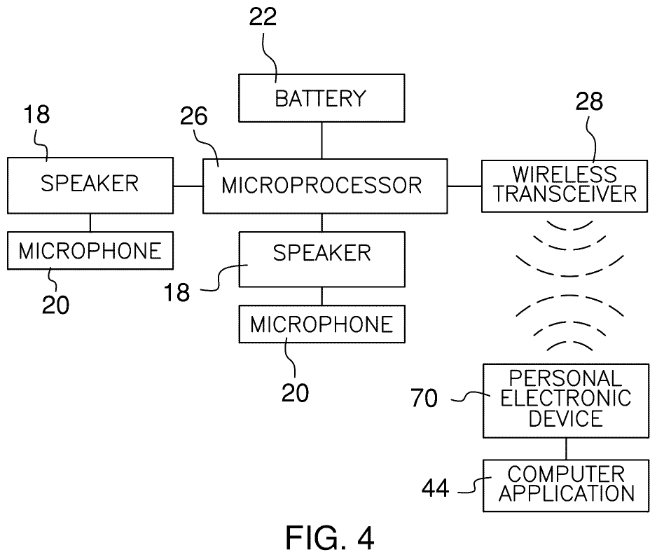

With reference to the first embodiment of the vehicle communication system 10 shown in FIGS. 1 through 4, the vehicle communication system 10 further includes an interior communication assembly 30 designed to be mounted at a vehicle dashboard 64 adjacent a steering wheel 66. The interior communication assembly 30 includes a speaker 18 and a microphone 20. As shown in FIGS. 1 and 2, the wiring 16 connects the interior communication assembly 30 to each of the exterior communication assembly 12 and the control assembly 14. The interior communication assembly 30 further includes control buttons 32 to permit a user to manually switch between receiving audio from the exterior communication assembly 12 and transmitting audio to the exterior communication assembly 12. The speaker 18 and the microphone 20 of the exterior communication assembly 12 are designed to be mounted within a driver side mirror 62. To further explain, FIG. 1 shows the speaker 18 of the exterior communication assembly 12 apparently on the driver side mirror 62, though this view is for clarity as the speaker 18 is mounted behind the mirror, as shown in FIG. 3. FIG. 4 shows a block diagram of the relationship of the various components.

In operation, a driver can manually operate the interior communication assembly 30, much like an intercom system, to converse with persons outside the vehicle 60. Alternatively, the driver or a passenger could use a personal electronic device 70, such as a mobile phone, that has been wirelessly connected to paired with the control assembly 14, such as via Bluetooth®, to operate the vehicle communication system 10. For example, a user could speak and listen via the personal electronic device 70, as well as possibly increase and decrease the volume.

FIG. 3 also shows that the vehicle communication system 10 further includes a backup power wire 34 designed to connect the control assembly 14 to a vehicle battery 68. This would supply power in the event of failure of the battery 22 in the control assembly 14. In another possible embodiment, the backup power wire 34 could be omitted.

With reference to the second embodiment of the vehicle communication system 10 shown in FIGS. 5 and 6, the exterior communication assembly 12 includes a camera 36 designed to view an area in front of a driver side door 74. The control assembly 14 is designed to transmit video received from the camera 36 to a personal electronic device 70 having a video screen. The exterior communication assembly 12 also includes a motion sensor 38 designed to detect movement of persons in an area in front of a driver side door 74. The control assembly 14 is designed to transmit a message to a personal electronic device 70 indicating detection of movement. The exterior communication assembly 12 includes a housing 40 designed to be mounted on a bottom surface of a driver side mirror 62 of a vehicle 60, wherein the speaker 18, the microphone 20, the camera 36, and the motion sensor 38 are positioned in the housing 40. The microprocessor 26 includes a memory 42 designed to store audio and video. The vehicle communication system 10 further includes a computer application 44 designed to be installed on a personal electronic device 70 to permit wireless operation of the vehicle communication system 10 via the microprocessor 26 and storage of recorded audio and video on a remote storage system.

The second embodiment of the vehicle communication system 10 shown in FIGS. 5 and 6 therefore not only allows for audio communication, but also allows for video communication. In addition, the second embodiment provides safety via the motion sensor 38 so persons in the vehicle 60 are alerted that someone is approaching the vehicle 60.

In one possible embodiment, the wireless transceiver 28 could allow communication over a wireless network to the personal electronic device 70, whether the user is in the vehicle 60 or not. The user could therefore remotely monitor the vehicle 60 and communicate with persons outside the vehicle 60. In one possible embodiment, the camera 36 and/or the motion sensor 38 could be incorporated into the first embodiment of the vehicle communication system 10 shown in FIGS. 1 through 4. In another possible embodiment, the interior communication assembly 30 could be incorporated into the second embodiment of the vehicle communication system 10 shown in FIGS. 5 and 6.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle communication system comprising:
an exterior communication assembly configured to be mounted at a driver side mirror of a vehicle, said exterior communication assembly comprising a speaker and a microphone;
a control assembly comprising a battery in a battery housing configured to be mounted under a vehicle dashboard, a microprocessor operatively connected to said battery, and a wireless transceiver operatively connected to said microprocessor, said wireless transceiver being configured to operatively connect said exterior communication assembly to a personal electronic device having a speaker and a microphone; and
wiring connecting said exterior communication assembly to said control assembly, said wiring being configured to be installed in and through a wiring conduit in a driver side mirror and a driver side door.

2. The vehicle communication system of claim 1, wherein:
the vehicle communication system further comprises an interior communication assembly configured to be mounted at a vehicle dashboard adjacent a steering wheel, wherein said interior communication assembly comprises a speaker and a microphone; and
said wiring connects said interior communication assembly to each of said exterior communication assembly and said control assembly.

3. The vehicle communication system of claim 2, wherein interior communication assembly further comprises control buttons to permit a user to manually switch between receiving audio from said exterior communication assembly and transmitting audio to said exterior communication assembly.

4. The vehicle communication system of claim 3, wherein said speaker and said microphone of said exterior communication assembly are configured to be mounted within a driver side mirror.

5. The vehicle communication system of claim 4, wherein said wireless transceiver and said microprocessor are disposed in said battery housing.

6. The vehicle communication system of claim 5, wherein the vehicle communication system further comprises a backup power wire configured to connect said control assembly to a vehicle battery.

7. The vehicle communication system of claim 1, wherein said exterior communication assembly comprises a camera configured to view an area in front of a driver side door, and said control assembly is configured to transmit video received from said camera to a personal electronic device having a video screen.

8. The vehicle communication system of claim 7, wherein said exterior communication assembly comprises a motion sensor configured to detect movement of persons in an area in front of a driver side door, and said control assembly is configured to transmit a message to a personal electronic device indicating detection of movement.

9. The vehicle communication system of claim 1, wherein said exterior communication assembly comprises a motion sensor configured to detect movement of persons in an area in front of a driver side door, and said control assembly is configured to transmit a message to a personal electronic device indicating detection of movement.

10. The vehicle communication system of claim 8, wherein said exterior communication assembly comprises a housing configured to be mounted on a bottom surface of a driver side mirror of a vehicle, wherein said speaker, said microphone, said camera, and said motion sensor are disposed in said housing.

11. The vehicle communication system of claim 8, wherein said microprocessor comprises a memory configured to store audio and video.

12. The vehicle communication system of claim 11, wherein the vehicle communication system further comprises a computer application configured to be installed on a personal electronic device to permit wireless operation of the vehicle communication system via said microprocessor and storage of recorded audio and video on a remote storage system.

13. The vehicle communication system of claim 12, wherein said wireless transceiver and said microprocessor are disposed in said battery housing.

14. The vehicle communication system of claim 13, wherein the vehicle communication system further comprises a backup power wire configured to connect said control assembly to a vehicle battery.

15. The vehicle communication system of claim 1, wherein:
said microprocessor comprises a memory configured to store audio; and
the vehicle communication system further comprises a computer application configured to be installed on a personal electronic device to permit wireless operation of the vehicle communication system via said microprocessor and storage of recorded audio on a remote storage system.
